(19) United States
(12) Patent Application Publication
(10) Pub. No.: US 2014/0248517 A1
(43) Pub. Date: Sep. 4, 2014

(54) POWER SUPPLY DEVICE

(71) Applicant: YAZAKI CORPORATION, Tokyo (JP)

(72) Inventor: Nobuaki YOSHIOKA, Kakegawa-shi (JP)

(73) Assignee: YAZAKI CORPORATION, Tokyo (JP)

(21) Appl. No.: 14/278,489

(22) Filed: May 15, 2014

Related U.S. Application Data
(63) Continuation of application No. PCT/JP2012/007297, filed on Nov. 14, 2012.

(30) Foreign Application Priority Data
Nov. 16, 2011 (JP) 2011-250505

(51) Int. Cl. H01M 10/48

(52) U.S. Cl. CPC H01M 10/482; H01M 2220/20
USPC 429/90

(57) ABSTRACT

A power supply device comprises: a battery assembly including stacked battery cells, the battery cells having electrodes, the electrodes of the adjacent battery cells being placed opposite to one another; and a battery linking body disposed on a side at which the electrodes of the battery assembly protrude, the battery linking body being configured to cover the protruding electrodes, the battery linking body including a substrate, the substrate having a circuit pattern for voltage detection and a terminal for electrode electrically connected to the circuit pattern and the electrodes, the terminal being fixed at a position of the substrate, the position corresponding to the electrodes being placed opposite to one another.

### CROSS REFERENCE TO RELATED APPLICATIONS

This application is a continuation application of International Application No. PCT/JP2012/007297, filed on Nov. 14, 2012, which claims priority to Japanese Patent Application No. 2011-250505, filed on Nov. 16, 2011, the entire contents of which are incorporated by references herein.

### BACKGROUND OF THE INVENTION

1. Field of the Invention

The present invention relates to a power supply device having stacked battery cells.

2. Description of the Related Art

Hybrid vehicles, electric vehicles and the like have a power supply device as a power source for driving an electric motor. Patent Application JP 2010-55885 A discloses such a power supply device as a conventional one. As shown in FIGS. 9 and 10, this power supply device 50 includes a battery assembly 51. The battery assembly 51 has stacked battery cells 52 that are arranged in two rows. Each battery cell 52 has a pair of electrodes (i.e. positive and negative electrodes) 52a and 52b provided on an upper surface thereof in protruding manner. Each pair of electrodes 52a and 52b of the adjacent battery cells 52 and 52 are electrically connected by a link terminal 53 and two clamp terminals 54 and 55. The link terminal 53 is formed as a part of a bus bar, and has a pair of linking contacts 53a and 53b. The linking contacts 53a and 53b are oriented corresponding to orientations of the electrodes 52a and 52b to be linked thereto. The clamp terminals 54 and 55 are formed as parts of a bus bar. The clamp terminal 54 clamps the electrode 52a of the batter cell 52 and the electrode 53a of the link terminal 53. The clamp terminal 55 clamps the electrode 52b of the batter cell 52 and the electrode 53b of the link terminal 53. A fork-shaped terminal 54A is integrally provided with the clamp terminal 54. A voltage checking wire W is pressed into the fork-shaped terminal 54A to electrically connect thereto. The link terminal 53 and the clamp terminals 54 and 55 are integrally fixed by a mounting member 56 which is made of synthetic resin.

In the conventional technique as described above, the battery cells 52 of the battery assembly 51 are connected in a series by the link terminal 53 and clamp terminal 54 and 55. Information on a voltage on the electrode of each battery cell 52 is output through the voltage checking wire W connected to the fork-shaped terminal 54a. Accordingly, an output status of each battery cells 52 can be detected.

### SUMMARY OF THE INVENTION

In the above conventional technique, the voltage checking wire W, the link terminal 53, the clamp terminals 54 and 55, and the mounting member 56 are used both to connect electrodes of adjacent battery cells 52 and 52 and to acquire the information on the voltages thereon. The voltage checking wire W, the link terminal 53, the clamp terminals 54 and 55, and the mounting member 56 are needed for every connection point of the adjacent electrodes. Therefore, the numbers of components, the assembling operations thereof and the like increase with increasing the number of battery cells 52 to be used. In addition, a space for setting the link terminal 53 and the clamp terminals 54 and 55 is needed for the every connection point. This unnecessarily causes the power supply device 50 to be larger and heavier.

The present invention has been made in order to solve the above problems, and the object thereof is to provide a power supply device which is capable of suppressing increase of the numbers of components and assembling operations thereof, and also which is capable of being miniaturized and being reduced in its weight.

An aspect of the present invention is a power supply device comprising: a battery assembly including stacked battery cells, the battery cells having electrodes, the electrodes of the adjacent battery cells being placed opposite to one another; and a battery linking body disposed on a side at which the electrodes of the battery assembly protrude, the battery linking body being configured to cover the protruding electrodes, the battery linking body including a substrate, the substrate having a circuit pattern for voltage detection and a terminal for electrode electrically connected to the circuit pattern and the electrodes, the terminal being fixed at a position of the substrate, the position corresponding to the electrodes being placed opposite to one another.

The terminal for electrode may be a fitting terminal configured to fit to the electrodes being placed opposite to one another. A fitting direction of the fitting terminal to the electrodes may be directed to a mounting direction of the battery lining body to the side of the battery assembly at which the electrodes thereof protrude.

The power supply device may further comprise an electrically conductive clip attached to the electrodes. In this case, the electrodes may be fitted to the fitting terminal in a state where the electrically conductive clip is attached to the electrodes.

According to the present invention, the connections between the electrodes in respective pairs and the acquisition of the information on the voltages thereon can be achieved by the substrate and the terminal disposed for each electrode. That is, the number of the components can be reduced compared with the conventional technique. A component required for every connection point of the paired electrodes is the terminal for electrode. This component can be set in a small space. Therefore, even if the number of the battery cells increase, it is possible to suppress increase of the numbers of the components and assembling operations thereof, as lower as possible. Thus, it is possible to miniaturize the device and reduce its weight and cost.

### BRIEF DESCRIPTION OF THE DRAWINGS

FIG. 1 is a perspective view illustrating a power supply device according to an embodiment of the present invention.

FIG. 2 illustrates the embodiment of the present invention in a state where a pair of electrodes is connected to a fitting terminal.

FIG. 3 is a perspective view illustrating a battery assembly according to the embodiment of the present invention.

FIGS. 4A and 4B illustrate the embodiment of the present invention. FIG. 4A is a perspective view illustrating a first battery cell, and FIG. 4B is a perspective view illustrating a second battery cell.

FIGS. 5A and 5B illustrates a battery cell linking body according to the embodiment of the present invention. FIG. 5A is a perspective view illustrating the battery linking body as seen from the outside, and FIG. 5B is a perspective view illustrating the battery linking body as seen from the outside, in which an insulating cover is dismounted.

FIGS. 6A and 6B illustrates the battery cell linking body according to the embodiment of the present invention. FIG. 6A is a perspective view illustrating the battery linking body as seen from the inside, and FIG. 6B is a perspective view illustrating the battery linking body as seen from the inside, in which an insulating cover is dismounted.

FIGS. 7A and 7B are perspective views illustrating the battery assembly cell. FIG. 7A is a perspective view illustrating electrodes of the battery assembly cell before being clipped by electrically conductive clips, and FIG. 7B is a perspective view illustrating the electrodes of the battery assembly cell after being clipped by the electrically conductive clips.

FIG. 8 illustrates the battery assembly and the battery cell linking body without an insulating case main body according to the embodiment of the present invention, in which each pair of electrodes is clipped by the electrically conductive clip.

FIG. 9 is an exploded perspective view of a conventional power supply device.

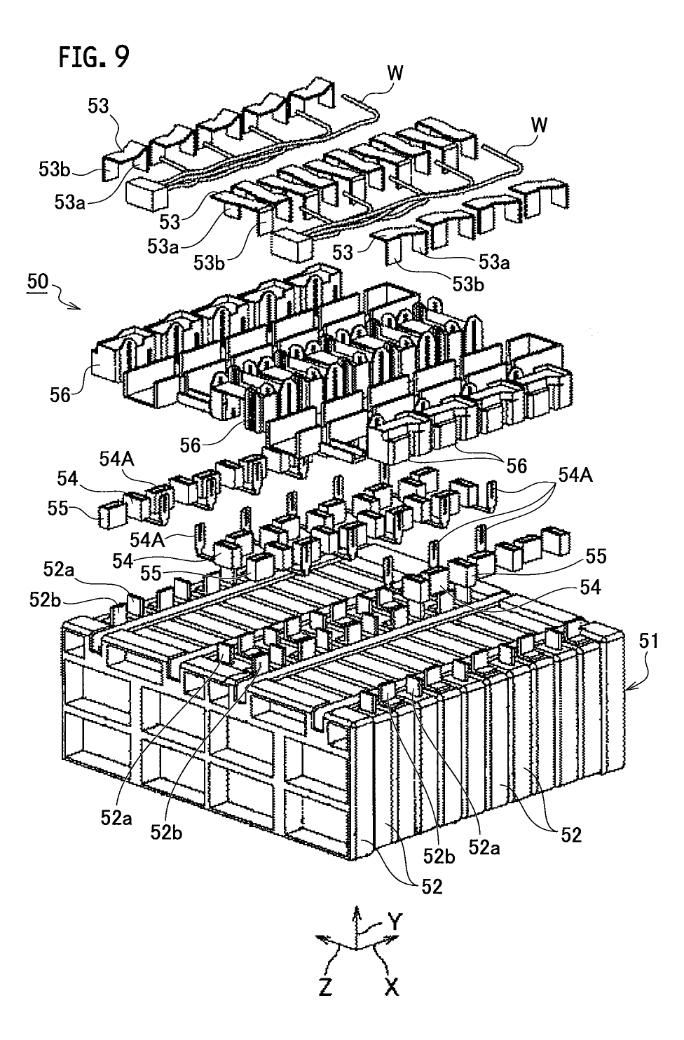

FIG. 10 is an expanded perspective view illustrating a main part of the conventional power supply device.

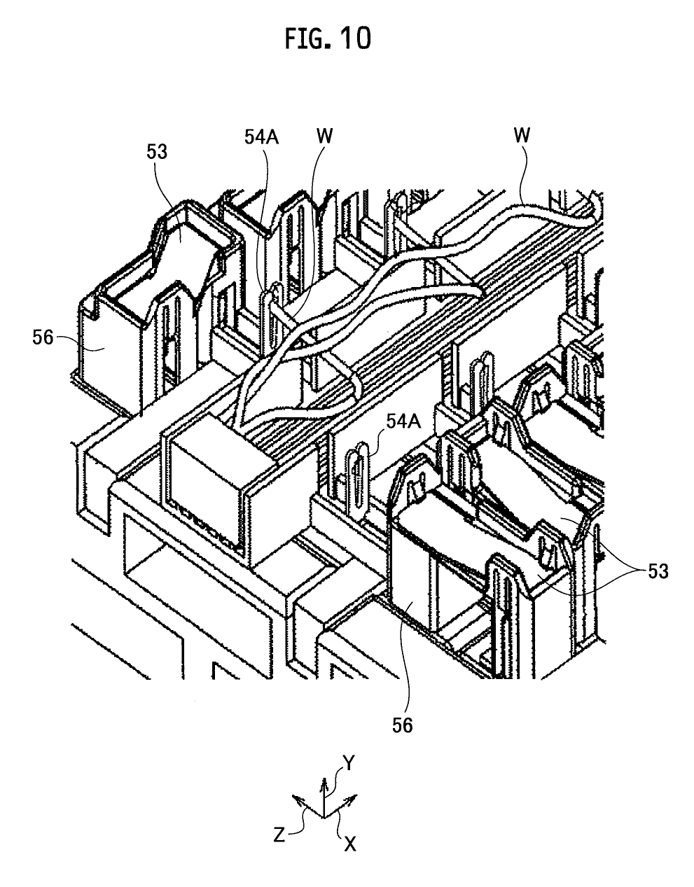

### DESCRIPTION OF THE PREFERRED EMBODIMENTS

Hereinafter, an embodiment of the present invention is described with reference to the drawings.

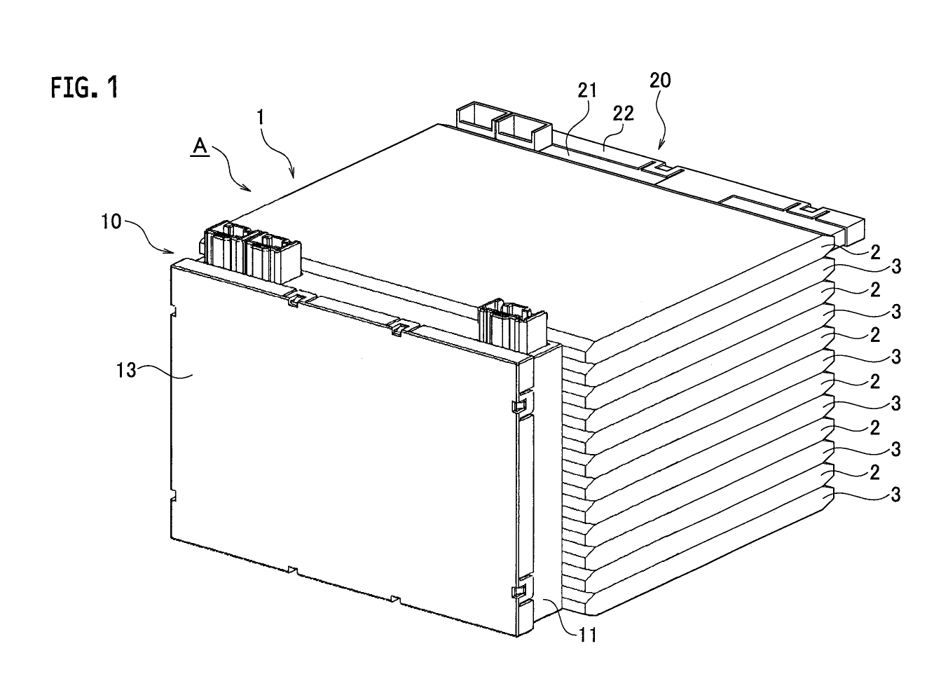

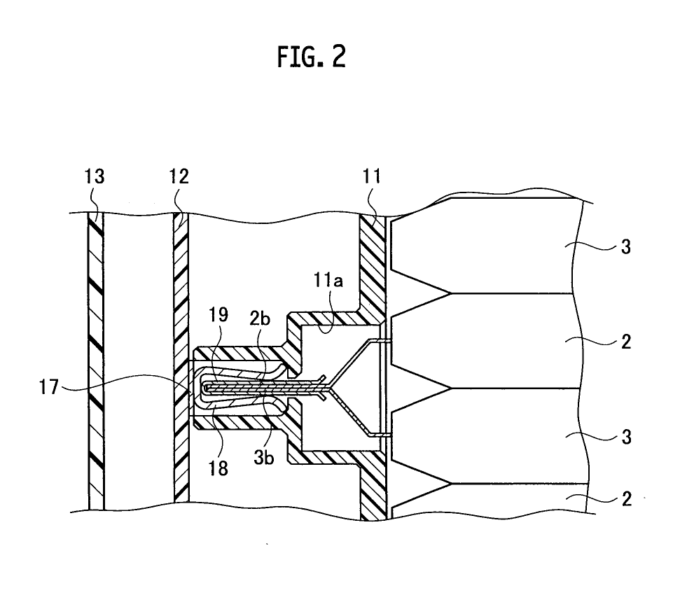

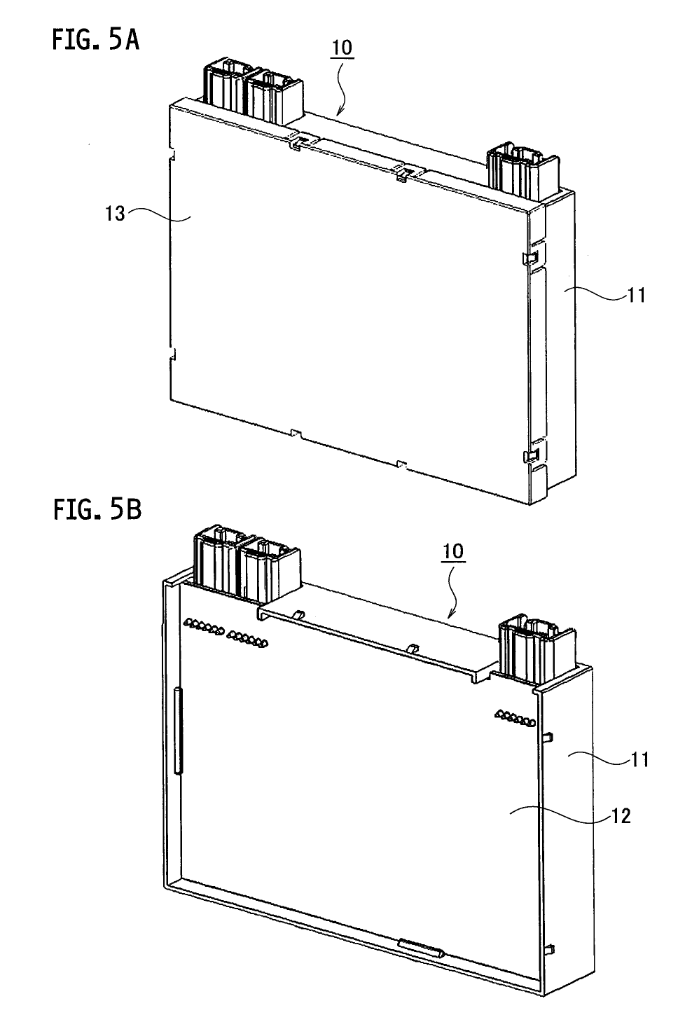

FIGS. 1 to 8 illustrate the embodiment of the present invention. As illustrated in FIGS. 1 and 2, a power supply device A comprises: a battery assembly 1 including stacked battery cells 2 and 3 (total twelve cells in this embodiment, for example); and a pair of battery linking bodies 10 and 20 disposed on both sides of the battery assembly 1.

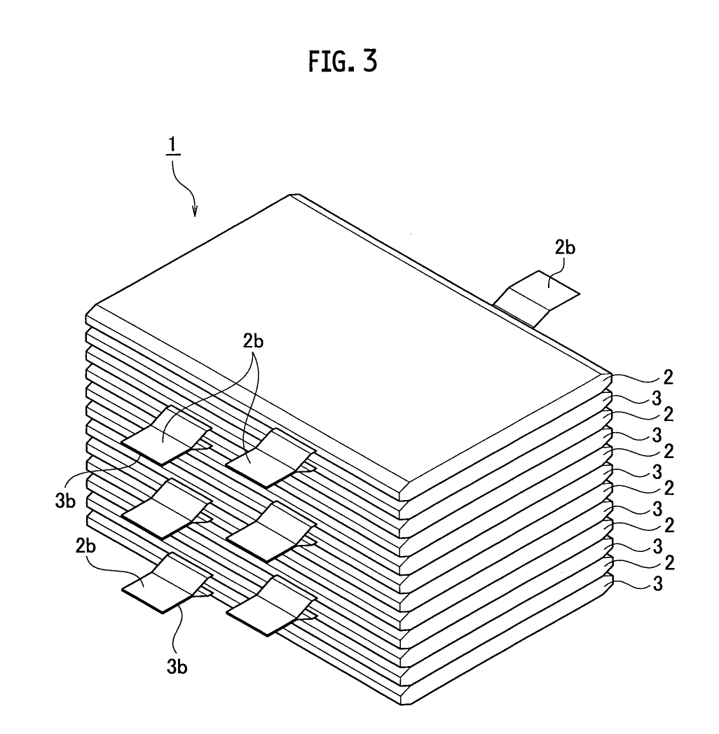

As illustrated in FIG. 3 in detail, the battery assembly 1 comprises twelve battery cells 2 and 3. Hereinafter, the battery cell 2 is referred to a first battery cell 2, and the battery cell 3 is referred to a second battery cell 3. The first battery cell has electrodes 2b, and the second battery cell has electrodes 3b. The positions of the electrodes 2b and 3b are different to each other.

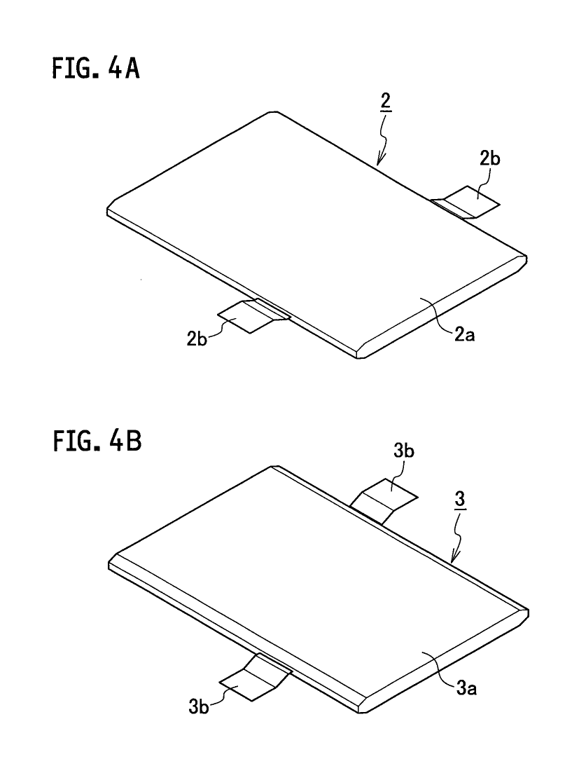

As illustrated in FIG. 4A, the first battery cell 2 includes a battery cell main body 2a formed into a rectangular and flat shape, a pair of electrodes (i.e. positive and negative electrodes) 2b and 2b respectively protruding from left and right side surfaces of the battery cell main body 2a. One of the paired electrodes 2b and 2b protrudes at the front side of the battery cell main body 2a, and the other one protrudes at the back side thereof. Both electrodes 2b and 2b are arranged at the same side of the battery cell main body 2a with reference to a center line of the battery cell main body 2a. That is, even when the battery cell main body 2a is flipped so that its front side is arranged to the backside or vice versa, the paired electrodes 2b and 2b are located at the same positions in a plan view except that their original left and right positions are reversed. Each electrode 2b is formed into a thin film, thin plate or the like.

As illustrated in FIG. 4B, the second battery cell 3 includes a battery cell main body 3a formed into a rectangular and flat shape, a pair of electrodes (i.e. positive and negative electrodes) 3b and 3b respectively protruding from left and right side surfaces of the battery cell main body 3a. One of the paired electrodes 3b and 3b protrudes at the front side of the battery cell main body 3a, and the other one protrudes at the back side thereof. Both electrodes 3b and 3b are arranged at the same side of the battery cell main body 3a with reference to a center line of the battery cell main body 3a. That is, even when the battery cell main body 3a is flipped so that its front side is arranged to the backside or vice versa, the paired electrodes 3b and 3b are located at the same positions in a plan view except that their original left and right positions are reversed. Each electrode 3b is formed into a thin film, thin plate or the like.

As illustrated in FIG. 3, the first and second battery cells 2 and 3 having the above configurations are alternately stacked. In this case, the electrodes 2b and 3b of the adjacent first and second battery cells 2 and 3, which have opposite polarities, are placed opposite to each other in contact with one another. Accordingly, in the battery assembly 1, the twelve battery cells 2 and 3 are connected in series.

As illustrated in FIGS. 2 and 5A to 6B in detail, the battery linking body 10 comprises: an insulating case main body 11; a substrate 12 disposed in a frame of the insulating case main body 11; an insulating cover 13 covering a space in the frame of the insulating case main body 11 from the outside.

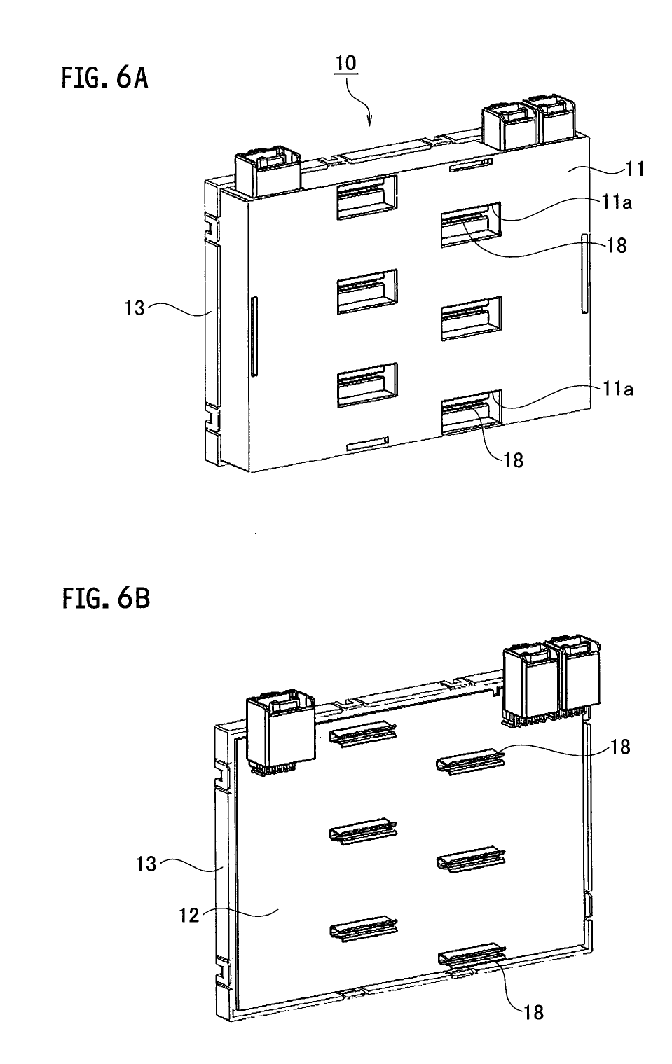

The insulating case main body 11 is provided with electrode insertion holes 11a. The electrode insertion holes 11a are provided at six positions corresponding to the electrodes 2b and 3b protruding from one side of the battery assembly 1. As seen in FIGS. 2 and 6A, each electrode insertion hole 11a has an entrance side part and an exit side part. The paired electrodes 2b and 3b are inserted into the exit side part though the entrance side part. An opening space in the entrance side part is wide. Alternatively, an opening space in the exit side part is narrow. Especially, an opening width of the exit side part is set to be equal to or less than a tip-end opening width of a fitting terminal 18 as described below.

A circuit pattern 17 for voltage detection (see FIG. 2) is formed on the substrate 12. The substrate 12 includes the fitting terminals 18 electrically connecting to the paired electrodes 2b and 3b. The fitting terminals 18 are fixed at positions of the substrate, which corresponds to the electrodes 2b and 3b protruding from the one side of the battery assembly 1. That is, the fitting terminals 18 are located at the same positions of the electrode insertion holes 11a of the insulating case main body 11. Thus, the tip-end opening of each fitting terminal. 18 is positioned so as to face the electrode insertion holes 11a of the insulating case main body 11. The fitting terminals 18 are fixed to the substrate by a method using soldering, pressing, clamping, or the like, and electrically connected to the circuit pattern 17. Each fitting terminal 18 sandwiches the paired electrodes 2b and 3b to be connected thereto. Each fitting terminal 18 vertically stands on the substrate 12. Therefore, its fitting direction is set to be along a direction in which the battery linking body 10 is approached and attached to a side of the battery assembly 1 at which the electrodes 2b and 3b protrude. The fitting terminal 18 having the above configuration is connected to the paired electrodes 2b and 3b protruding from the one side of the battery assembly 1 by a connection structure as described below.

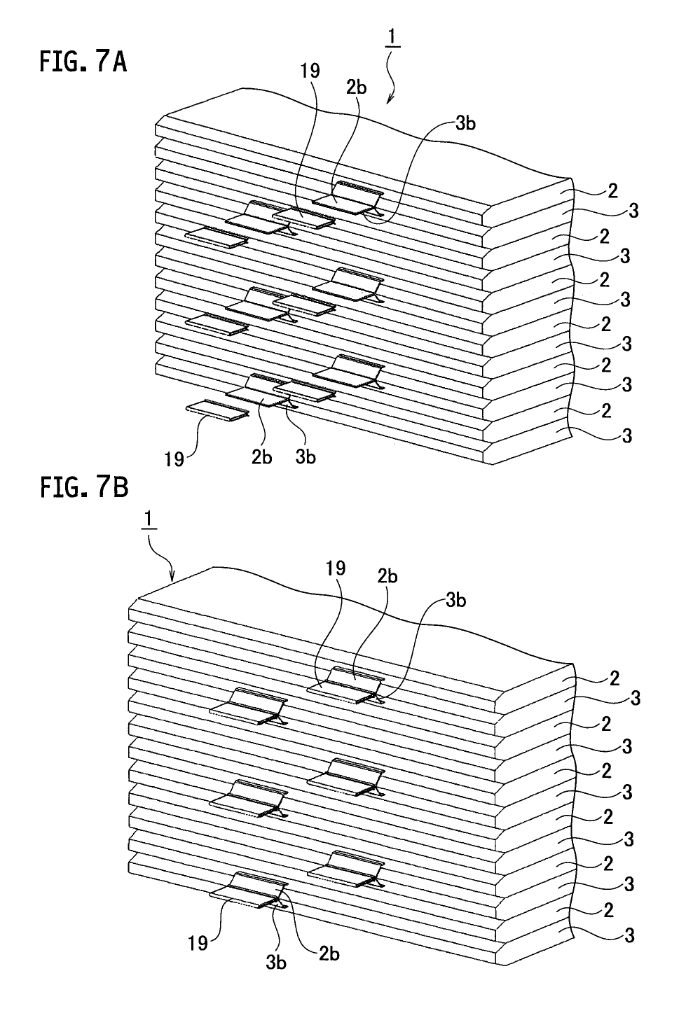

As illustrated in FIGS. 7A and 7B, an electrically conductive clip (referred to as clip, hereinafter) 19 is attached to each pair of the electrode 2b and 3b. The clip 19 is made of electrically conductive material. The clip 19 sandwiches the paired electrodes 2b and 3b. Here, the clip 19 and the electrodes 2b and 3b are mutually connected by a method using ultrasonic waves, bonding or the like. As seen in FIG. 2, the paired electrodes 2b and 3b are inserted through the electrode insertion hole 11a of the insulating case main body 11, and thus fitted to the fitting terminal 18 together with the clip 19. In other words, the paired electrodes 2b and 3b are electrically connected to the fitting terminal 18 through the clip 19.

The substrate 12 is mounted in a residual space in the insulating case main body 11, which is not occupied by the electrodes 2b and 3b. In addition, the electrodes 2b and 3b are directly connected to the fitting terminal 18 fixed to the substrate 12. Accordingly the battery linking body 10 can be miniaturized, and the mounting area of the substrate 12 can be expanded.

As described below, the information on voltages on the electrodes 2b and 3b at both sides of the battery linking bodies 10 and 20 is sent to the substrate 12. The substrate 12 has a circuit for detecting abnormal voltages of the battery cells 2 and 3. This circuit determines whether or not the output voltages of the battery cells 2 and 3 are abnormal.

The insulating cover 13 covers the accommodation space for the substrate from the outside. Accordingly, the battery linking body 10 electrically insulates the electrode 2b and 3b that protrude from the one side of the battery assembly 1.

The battery linking body 20 has a similar configuration of the battery linking body 10. The battery linking body 20 includes an insulating case main body 21 (see FIG. 1), an insulating cover 22 (also see FIG. 1), and a substrate (not shown). The battery linking body 20 electrically insulates the electrodes 2b and 3b that protrude from the other side of the battery assembly 1. The voltage information at the electrodes 2b and 3b disposed at the battery linking body 20 side are sent to the substrate 12 in the battery linking body 10 via a wire for voltage detection (not shown).

In the insulating case main body 21, a pair of output terminals (now shown) is provided. An output of the power supply device A is obtained from the pair of the output terminals.

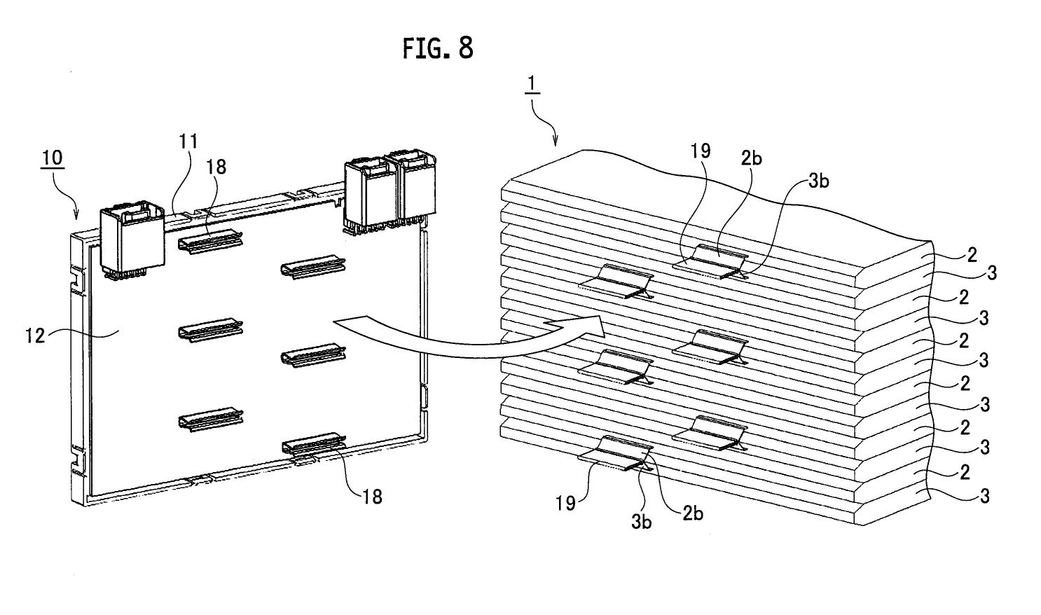

Next, an outline of the assembling operations of the power supply device A will be described. As illustrated in FIG. 8, the clip 19 is attached to the paired electrodes 2b and 3b protruding from the one side of the battery assembly 1. The clip 19 and the electrodes 2b and 3b are mutually connected by the method using ultrasonic waves, bonding or the like. Next, the battery linking body 10 is approached to the battery assembly 1 along a direction in which the battery linking body 10 faces the one side of the battery assembly 1, and each pair of the electrodes 2b and 3b is inserted into the corresponding electrode insertion hole 11a of the insulating case main body 11. With this insertion, a tip end of the clip 19 inserted in the electrode insertion hole 11a is located in front of a tip-end opening of the fitting terminal 18. When the battery lining body 10 is pushed toward the battery assembly 1 and is further approached thereto, the paired electrodes 2b and 3b, to which the clip 19 is attached, are fitted to the corresponding fitting terminal 18.

The battery linking body 20 is assembled in a similar way to the assembling operation of the battery linking body 10 as described above.

As described above, the power supply device A according to the present embodiment comprises: the battery assembly 1, and the battery linking bodies 10 and 20. The battery linking body 10 includes the substrate 12. The substrate 12 has the circuit pattern 17 for voltage detection, and the at least one fitting terminal 18 fixed thereto. The fitting terminal 18 is located at a position on the substrate 12, which corresponds to the electrodes 2b and 3b placed opposite to one another, thereby connecting to them. Therefore, the connections between the electrodes 2b and 3b in respective pairs and the acquisition of the information on the voltages thereon can be achieved by the substrate 12 and the fitting terminal 18. Specifically, the connections and acquisition as described above can be achieved by fewer components than those of the conventional power supply device. In the present embodiment, a component required for every connection points of the paired electrodes is only the fitting terminal 18. This component can be set in a small space. Therefore, even if the number of the battery cells 2 and 3 increase, it is possible to suppress increase of the numbers of the components and assembling operations thereof, as lower as possible. Thus, it is possible to miniaturize the device and reduce its weight and cost.

The substrate 12 includes the circuit for detecting the abnormal voltages of the battery cells 2 and 3. Accordingly, it is possible to further reduce the number of the components of the power supply device, thus further miniaturization and reduction of the weight become possible.

As described above, a fitting direction of the fitting terminal 18 to the paired electrodes 2b and 3b is directed to a mounting direction of the battery lining body 10 to the side of the battery assembly at which the paired electrodes 2b and 3b thereof protrude. That is, the fitting terminal 18 is connected to the paired electrodes 2b and 3b in a mounting process of the battery linking body 10 to the battery assembly 1. Accordingly, no other connection operation (such as soldering, electric resistance welding and the like) is required. Thus, a good assembling operation can be obtained. In addition, since the above connection operation is not required after the battery linking body 10 is mounted to the one side of the battery assembly, the insulating cover 13 does not have to have an open-and-close structure such as a door or the like.

As described above, the electrically conductive clip 19 is attached to the paired electrodes 2b and 3b. Only with this attachment, the electrodes 2b and 3b are fitted to the fitting terminal 18 to be connected thereto. In other words, the electrodes 2b and 3b are fitted to the fitting terminal 18 in a state where the clip 19 is attached to the electrodes 2b and 3b. That is, it is possible to securely and electrically connect the electrode 2a and the electrode 3b, and also possible to smoothly and securely fit the paired electrodes 2b and 3b to the fitting terminal 18.

In the above embodiment, the paired electrodes 2b and 3b and the clip 19 are mutually connected by the method using ultrasonic waves, soldering or the like. However, they may be mutually connected only by clipping (clamping) the paired electrodes 2b and 3b by the clip 19. This method can simplify the assembling operation.

Further, the clip 19 may be omitted. In this case, the paired electrodes 2b and 3b are directly connected to the fitting terminal 18. This method can simplify the assembling operation, and can reduce the number of components and the costs.

In the above embodiment, the fitting terminal 18 is composed of a pair of clipping pieces (arms). However, the fitting terminal 18 may be composed of a known male terminal having a spring therein.

In the second embodiment, as substantially similar to the first embodiment, the connections between the electrodes 2b and 3b in respective pairs and the acquisition of the information on the voltages thereon can be achieved by fewer components than those of the conventional power supply device.

What is claimed is:

1. A power supply device comprising:
a battery assembly including stacked battery cells, the battery cells having electrodes, the electrodes of the adjacent battery cells being placed opposite to one another; and
a battery linking body disposed on a side at which the electrodes of the battery assembly protrude, the battery linking body being configured to cover the protruding electrodes, the battery linking body including a substrate, the substrate having a circuit pattern for voltage detection and a terminal for electrode electrically connected to the circuit pattern and the electrodes, the terminal being fixed at a position of the substrate, the position corresponding to the electrodes being placed opposite to one another.

2. The power supply device according to claim 1, wherein the terminal for electrode is a fitting terminal configured to fit to the electrodes being placed opposite to one another, a fitting direction of the fitting terminal to the electrodes is directed to a mounting direction of the battery lining body to the side of the battery assembly at which the electrodes thereof protrude.

3. The power supply device according to claim 2, further comprising
an electrically conductive clip attached to the electrodes, wherein
the electrodes are fitted to the fitting terminal in a state where the electrically conductive clip is attached to the electrodes.

4. The power supply device according to claim 1, wherein
the substrate includes a detection circuit for abnormal voltages of the battery cells.
